(19) United States
(12) Patent Application Publication
(10) Pub. No.: US 2013/0175210 A1
(43) Pub. Date: Jul. 11, 2013

(54) ODOR TREATMENT DEVICE FOR SEPTIC TANKS

(71) Applicants: Industry-Academia Cooperation Group Of Sejong, Seoul (KR); EXEN ENVIRONMENTAL INC., Ansan (KR)

(72) Inventors: Ji Hyeon SONG, Seoul (KR); Hea Young AHN, Incheon (KR); Jin Sung KIM, Seoul (KR); Tae Haeng LEE, Ansan (KR)

(73) Assignees: EXEN ENVIRONMENTAL INC., Ansan (KR); Industry-Academia Cooperation Group Of Sejong University, Seoul (KR)

(21) Appl. No.: 13/675,370

(22) Filed: Nov. 13, 2012

(30) Foreign Application Priority Data
Jan. 6, 2012 (KR) 10-2012-0002120

(51) Int. Cl. C02F 1/467

(52) U.S. Cl. CPC C02F 1/4672
USPC 210/195.1; 204/237; 204/230.2; 204/228.6; 204/228.3

(57) ABSTRACT

An odor treatment device for septic tanks, including an electrolytic oxidation module that has one or multiple electrode sets and processes odor precursors or organic matters that cause odor from organic wastewater and excretion flow inside by an electrolytic oxidation reaction; a supply line through which the excretion is supplied from a septic tank to the electrolytic oxidation module; a circulation line through which the organic wastewater and excretion with the odor precursors and organic matters processed by the electrolytic oxidation module are circulated back to the septic tank; a circulation pump that is disposed in the supply line and continuously circulates the organic wastewater and excretion; a direct current power supply unit that supplies direct current to the electrode sets of the electrolytic oxidation module; and a pump power supply unit that supplies power to the circulation pump.

### CROSS-REFERENCE TO RELATED APPLICATIONS

This application claims the priority of Korean Patent Application No. 10-2012-0002120 filed on Jan. 6, 2012, in the Korean Intellectual Property Office, the disclosure of which is incorporated herein by reference.

### BACKGROUND OF THE INVENTION

1. Field of the Invention

The present invention relates to an odor treatment device for septic tanks, specifically to one that decomposes and removes odor precursors and organic matters that cause odor emissions from organic wastewater and excrements in septic tanks by using an electrolytic oxidation system that generates oxidants, including hypochlorous acid, at the surface of electrodes.

2. Description of the Related Art

The general public's complaints about odors emitted from combined sewer systems are consistently growing, and the odor problem has become an important environmental issue in metropolitan areas. In particular, odor emissions from combined sewer facilities such as manholes, sewer pipelines, and septic tanks in urban areas are unpleasant aesthetic pollution to the general public.

Organic wastewater containing high-density suspended solids, discharged from kitchens and toilets, is first introduced to septic tanks, and the organic solid matters are biologically decomposed by microorganisms. Inside septic tanks, where oxygen is neither supplied nor transferred to the liquid phase, dissolved oxygen can be rapidly depleted in the sediment and a complete anaerobic state commonly develops.

Because the anaerobic decomposition is a cost-effective method for controlling high-strength organic wastes, septic tanks are generally installed in combined sewer systems. However, high-density odor may be generated from septic tanks under these complete anaerobic conditions, and it diffuses out to manhole covers and connected pipelines.

The quantity and quality of odor emissions from septic tanks are greatly influenced by many factors such as weather conditions and configuration of septic tanks, as well as by the amounts of odor precursors and organic matters introduced to the facilities. In addition, the odorous compounds generated from septic tanks and their chemical composition can change depending on the amounts and the oxidation states of organic matters deposited at the bottom of the facilities.

The odorous compounds generated from septic tanks are largely classified into volatile sulfur compounds (VSCs), volatile nitrogenous compounds (VNCs), and volatile fatty acids (VFAs). The VSCs in reduced states are known to be the major odorous compounds of sewer and septic tank emissions. For example, sulfate ions in organic wastewater and sewerages can be transformed to reduced-state sulfur compounds such as hydrogen sulfide, such that large amounts of odor-causing substances are generated.

Periodic cleaning of the insides of septic tanks is a generally used method for controlling the odor problem. However, without taking into consideration the operational conditions and without providing enough maintenance efforts, the method commonly fails to effectively control the high-strength odor emissions. Accordingly, the odor problems that are commonly caused from septic tanks are not effectively controlled and no specific device has been designed or installed at the present time. Therefore, a new device for effectively removing not only the odorous compounds but also the odor-causing precursors needs to be developed and applied to septic tanks.

### SUMMARY OF THE INVENTION

An aspect of the present invention provides an odor treatment device for septic tanks that effectively decomposes and removes odor precursors as well as organic matters that cause odor from organic wastewater and excrements by being disposed at places where the odor is mainly generated inside septic tanks, while also keeping intact the function of septic tanks to the extent possible.

According to an aspect of the present invention, an odor treatment device for septic tanks is provided that includes: an electrolytic oxidation module that has one or multiple electrode sets and processes odor precursors or organic matters that cause odor from wastewater flow inside by the electrolytic oxidation reaction; a supply line through which organic wastewater is supplied from a septic tank to the electrolytic oxidation module; a circulation line through which wastewater with odor precursors and organic matters processed by the electrolytic oxidation module is recirculated back to the septic tank; a circulation pump that is disposed in the supply line and continuously circulates wastewater flow; a direct current (DC) power unit that supplies DC to the electrode sets of the electrolytic oxidation module; and a pump power supply unit that supplies electricity to the circulation pump.

The odor treatment device for septic tanks may further include a central control unit that controls the DC power supply unit and the pump power supply unit. The odor treatment device for septic tanks may further include an odor sensor that measures odor density at an exhaust port of the septic tank, in which the central control unit may regulate power supplied to the electrode sets of the electrolytic oxidation module from the DC power supply unit based on the degree of odor measured by the odor sensor. The odor treatment device for septic tanks may further include an electric conductivity (EC) meter that measures conductivity of wastewater stream in the septic tank, in which the central control unit may control the pump power supply unit to control a flow rate of the circulation pump based on the EC measured by the EC meter. The odor treatment device for septic tanks may further include an effluent flow meter that measures an outflow rate at an outlet of the septic tank, in which the central control unit may control the pump power supply unit to control a flowrate of the circulation pump based on the outflow rate measured by the effluent flow meter.

Further, cathodes and anodes, both metallic plates or meshes or cylindrical rods, may be sequentially disposed in parallel to be spaced from one another in the electrode sets of the electrolytic oxidation module.

The septic tanks, that have been constructed and installed into the combined sewer lines up to now, commonly consist of a precipitation tank, a first decomposition tank, and a second decomposition tank sequentially disposed along the flow of the organic wastewater from the inlet. The supply line of the odor treatment device maybe connected to the first decomposition tank or the second decomposition tank, and the circulation line may be connected to the second decomposition tank. The circulation pump maybe disposed in the first decomposition tank or the second decomposition tank where the supply line is connected. Further, a filter unit for filtering any large solid particles may be disposed in the inlet of the circulation line, and an outlet end of the circulation line may extend downward through the filter unit.

The electrolytic oxidation module may further include a module case that has an inlet pipe and an outlet pipe for the wastewater flow and includes one or multiple electrode sets.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating the configuration of an odor treatment device for septic tanks according to an embodiment of the present invention;

FIGS. 2A to 2C are a front plan view, and a side view of the electrolytic oxidation module illustrated in FIG. 1, respectively;

FIG. 3 is a graph showing a test result that shows the amount of hydrogen sulfide generated in a septic tank equipped with the odor treatment device for the septic tank illustrated in FIG. 1; and

FIG. 4 is a graph showing a test result of a comparative example which shows the amount of hydrogen sulfide generated in another equivalent septic tank not equipped with the odor treatment device.

### DETAILED DESCRIPTION OF THE PREFERRED EMBODIMENT

Exemplary embodiments of the present invention will now be described in detail with reference to the accompanying drawings.

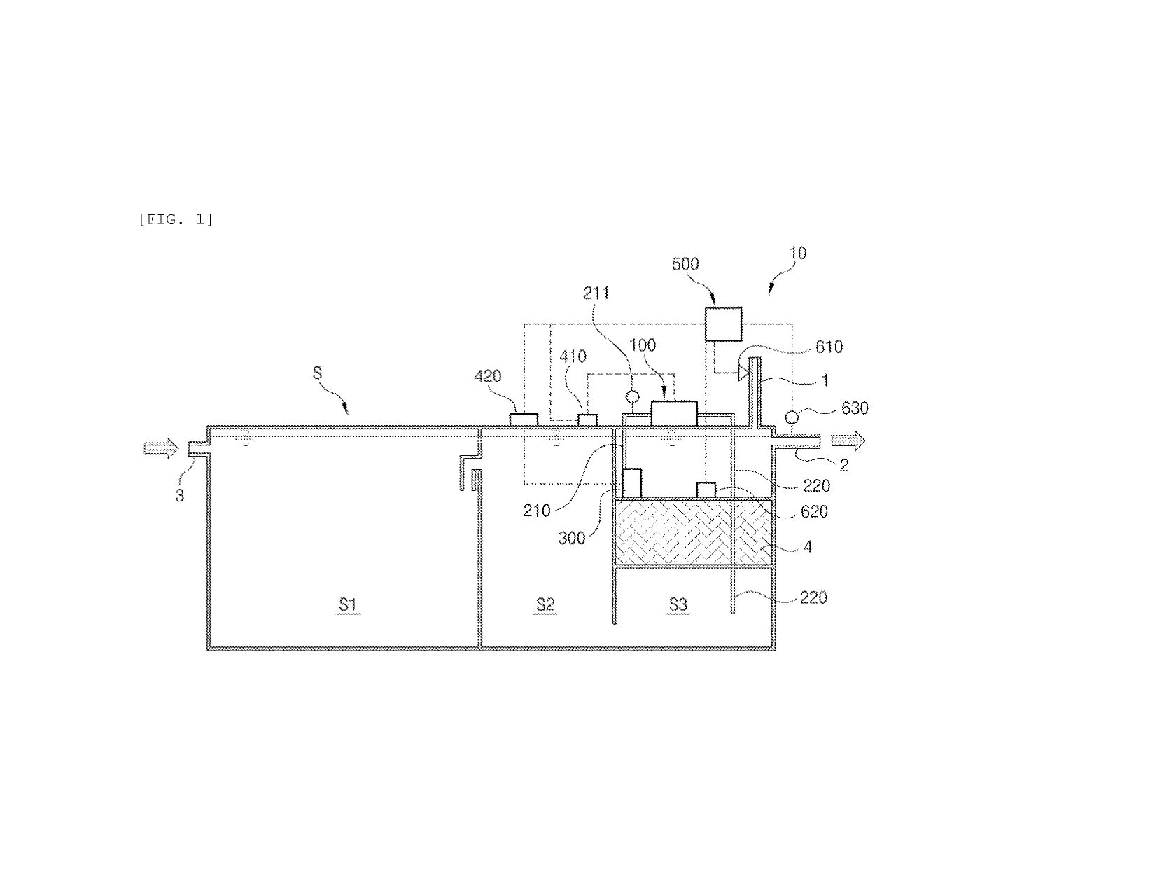

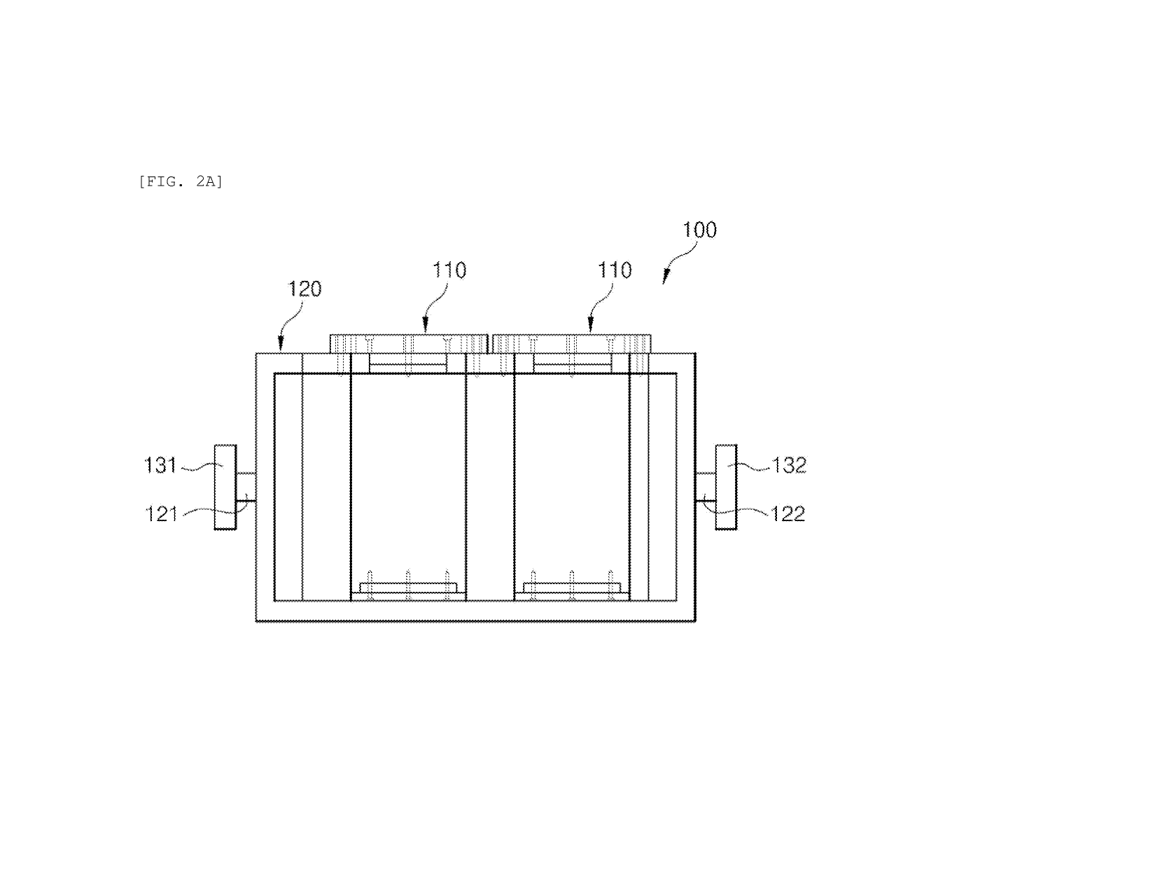

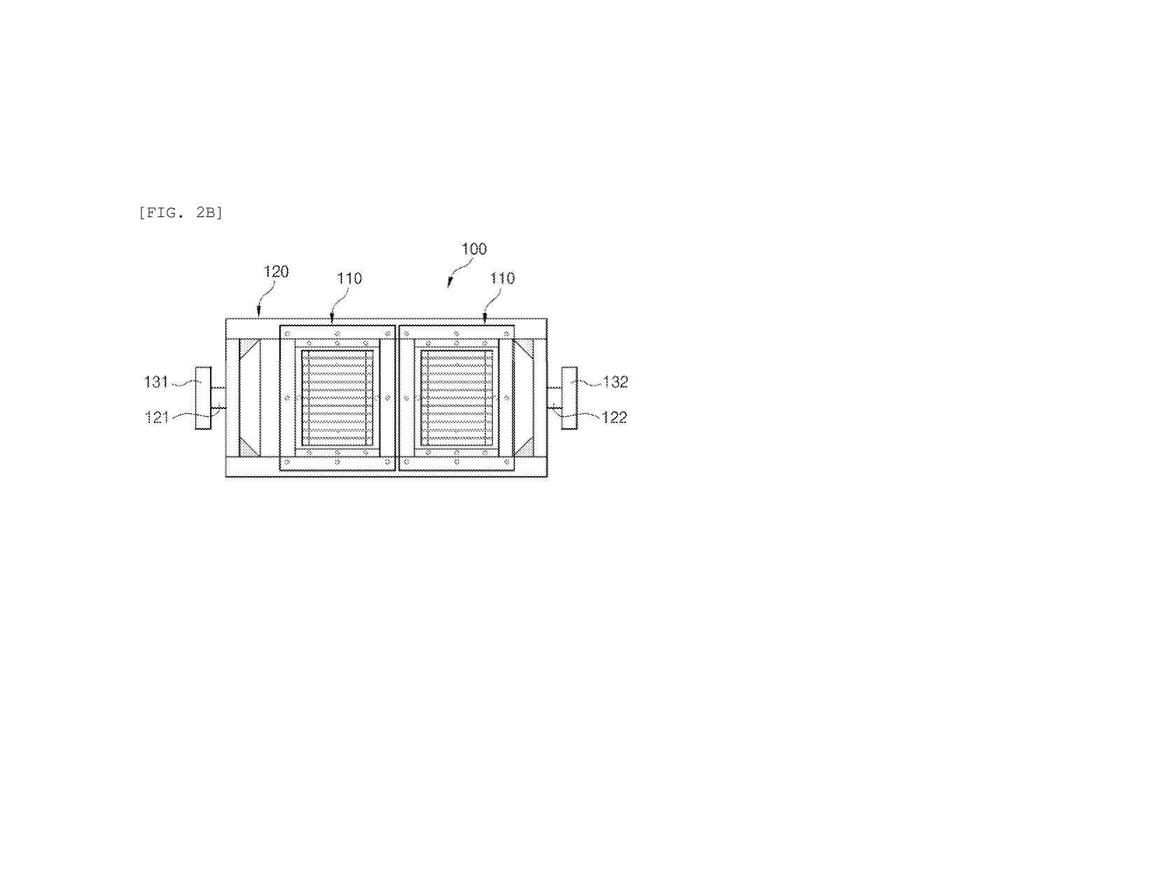

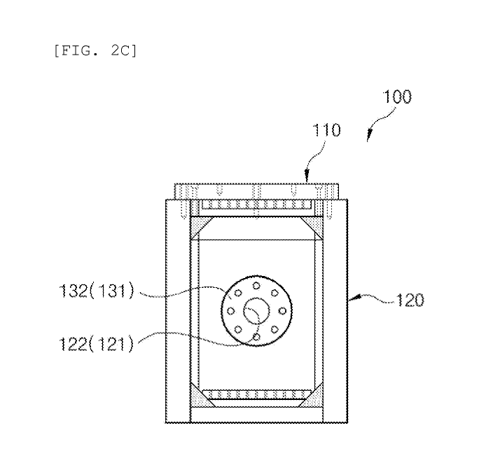

FIG. 1 is a view illustrating the configuration of the odor treatment device for a septic tank according to an embodiment of the present invention and FIGS. 2A to 2C are a front plan view, and a side view of an electrolytic oxidation module illustrated in FIG. 1, respectively.

Referring to the figures, an odor treatment device 10 for septic tanks according to an embodiment of the present invention decomposes and removes odor precursors and organic matters that cause odor from organic wastewater in a septic tank S, using the electrolytic oxidation, which generates oxidants at the surface of electrodes. For the operation, the odor treatment device 10 for septic tanks includes an electrolytic oxidation module 100, a wastewater supply line 210, a circulation line 220, a circulation pump 300, a DC power supply unit 410, and a pump power supply unit 420.

It is exemplified in the embodiment of the present invention that the septic tank S is divided by a precipitation tank S1, a first decomposition tank S2, and a second decomposition tank S3 that are sequentially disposed along the flow of the organic wastewater from an inlet 3 thereof. The organic wastewater that flows into the inlet 3 of the septic tank S is discharged to the outside through an outlet 2 after sequentially passing through the precipitation tank S1, the first decomposition tank S2, and the second decomposition tank S3, a filter unit 4 for filtering is disposed in the second decomposition tank S3, and the second decomposition tank S3 has a gas exhaust pipe 1 through which an odorous gas generated from the organic wastewater can be discharged.

The electrolytic oxidation module 100 removes odor precursors and organic matters that cause odor from the organic wastewater flowing inside due to the electrolytic oxidation reaction. For this operation, as illustrated in FIGS. 2A to 2C, one or multiple of metal electrode sets 110 through which a current flows is disposed in an insulating module case 120. Further, the module case 120 further has an inlet pipe 121 and an outlet pipe 122 for the wastewater circulation and may have a first flange 131 and a second flange 132 provided at the ends of the inlet pipe 121 and the outlet pipe 122, respectively, to be connected with the supply line 210 and the circulation line 220, which are described below.

The electrode sets 110 are disposed in parallel such that cathodes and anodes are sequentially spaced from one another without partitions. In this way, as the electrodes are alternately arranged and both sides of the electrodes are used in the electrode sets 110, the surface area can be maximized, and accordingly, the efficiency of the electrolysis is improved. Perforated metallic plates or woven wire meshes may be used for the electrodes to maximize the surface area. In particular, it is preferable that the anode is made from an insoluble metal plate with high durability. A direct current is supplied to the electrode sets 110 from the DC power supply unit 410. That is, a positive (+) current is connected to the anode, a negative (−) current is connected to the cathode, and direct variable voltage is supplied to the electrodes, such that it is possible to easily control the amount of electrical power. In this structure, as the organic wastewater continuously passes through between the electrodes, odor compounds and organic matters in the wastewater are decomposed and removed by the electrolytic reaction.

The supply line 210 functions to supply the wastewater from the septic tank S to the electrolytic oxidation module 100. For the function, the supply line 210 may be connected with the first decomposition tank S2 or the second decomposition tank S3. Further, the circulation pump 300 is disposed in the supply line 210 to continuously supply the wastewater. Further, the electricity for the circulation pump 300 is supplied from the pump power supply unit 420, in which the electricity may be alternating current variable power. Further, the circulation pump 300 may be disposed so as to be soaked in the first decomposition tank S2 or the second decomposition tank S3 where the supply line 210 is connected. On the other hand, reference numeral ‘211’ that is not described indicates an inflow meter that measures the influent amount of the wastewater that flows into the electrolytic oxidation module 100.

In the circulation line 220, the wastewater with odor precursors and organic matters removed by the electrolytic oxidation module 100 is circulated back to the septic tank S by the circulation pump 300. The circulation line 220 may be connected with the second decomposition tank S3, in which an outlet end 221 of the circulation line 220 preferably extends downward through the filter unit 4.

In the embodiment of the present invention described above, the odor treatment device 10 for a septic tank may further include a central control unit 500 that controls the DC power supply unit 410 and the pump power supply unit 420.

Further, it is possible to measure the odor by disposing an odor sensor 610 in the gas exhaust pipe 1 of the septic tank S. The central control unit 500 controls the voltage that is supplied from the DC power supply unit 410 to the electrode set 110 of the electrolytic oxidation module 100, based on the degree of odor measured by the odor sensor 610. That is, it is possible to reduce unnecessary waste of power to the minimum by controlling the variable voltage supplied to the electrode set 110 based on the measured value of the odor by the odor sensor 610.

Further, an electric conductivity (EC) meter 620 that can measure EC that depends on the degree of electrolytes and ions in the wastewater may be further disposed. Accordingly, the central control unit 500 can control the pump power supply unit 420 to adjust the flow rate in the circulation pump 300, based on the EC measured by the EC meter 620. That is, it is possible to control the circulation rate of the wastewater that flows into the electrolytic oxidation module 100 by measuring the EC that depends on the ionic electrolyte concentrations of the wastewater flowing inside, and it can reduce the possibility of an accident such as an electric shock due to an over current.

Further, it is possible to measure the outflow amount of discharged wastewater by disposing an effluent flow meter 630 in the outlet 2 of the septic tank S. Accordingly, the central control unit 500 controls the pump power supply unit 420 to adjust the flow rate in the circulation pump 300, based on the outflow amount measured by the effluent flow meter 630.

As described above, using the odor treatment device 10 for septic tanks according to the present invention, it is possible to basically preclude the generation of odorous compounds by performing the electrolytic oxidation processing on odor precursors and organic matters in the wastewater and by preventing secondary byproducts from being generated. This can be achieved by separately disposing the electrolytic oxidation module 100 that uses an oxidation reaction, while keeping the function of the septic tank S installed at a site as much as possible.

Further, it is possible to not only effectively reduce odor by changing and automatically controlling the flow rate of the circulation pump and the voltage that is applied from the DC power supply unit based on the EC in the wastewater and the density of odor generated in the septic tank S, but also to considerably reduce energy consumption.

The amount of hydrogen sulfide (H₂S) generated when the odor treatment device 10 for septic tanks according to the present invention is installed is described hereafter with a comparative example. The test conditions are as follows. That is, hydrogen sulfide was measured at three parts of the precipitation tank S1 of the septic tank S, the first decomposition tank S2, and the outlet 2 of the septic tank S. The measuring was performed ten times during a two-week period of continuous operation, and the average values are shown. The flow rate from the circulation pump 300 was set to be 3.6 m³/min.

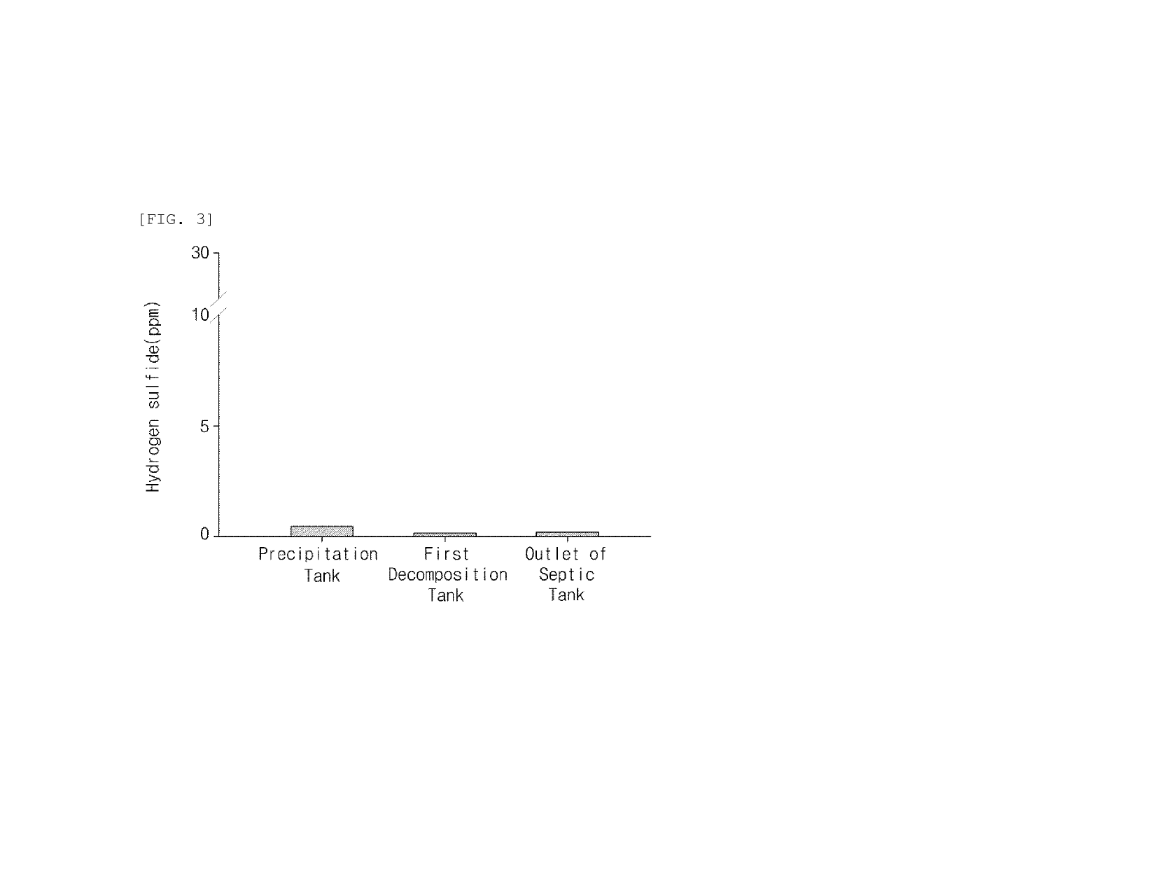

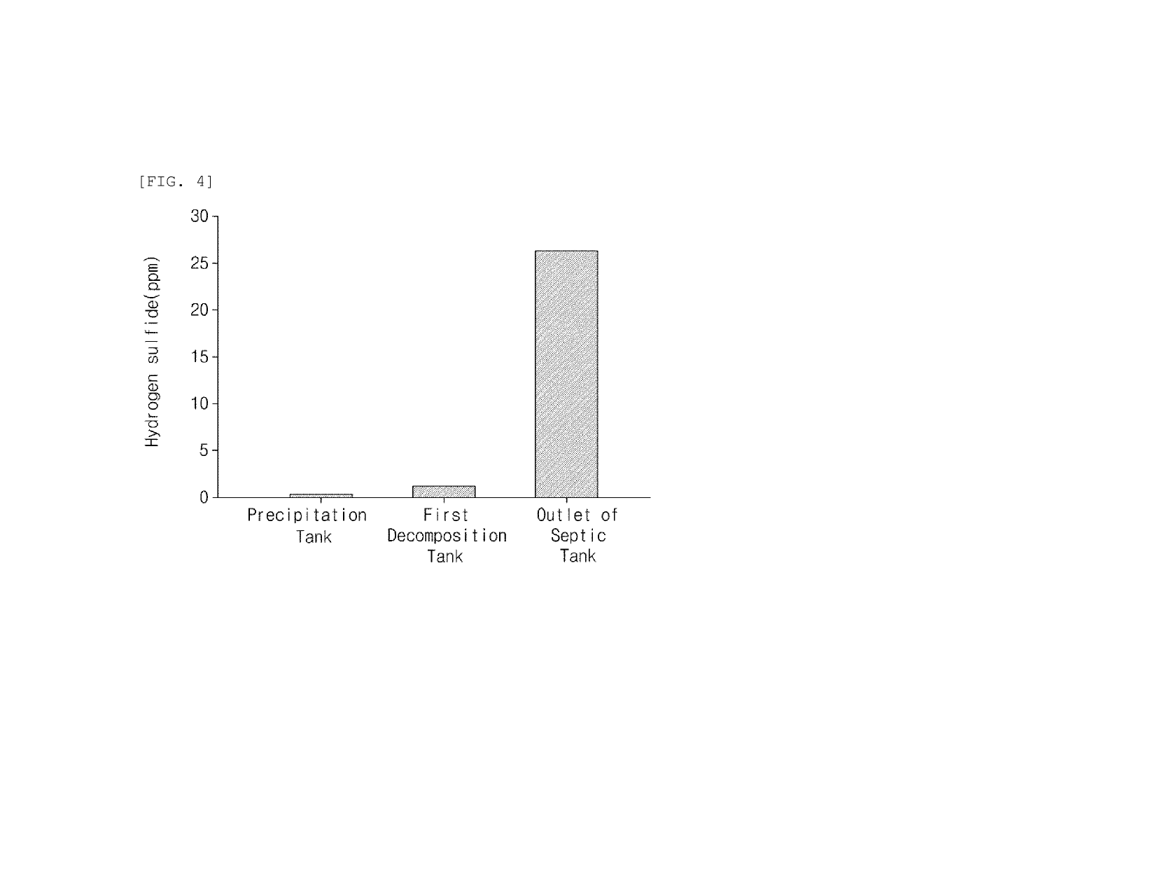

FIG. 3 is a graph showing a test result that shows the amount of hydrogen sulfide generated in a septic tank equipped with the odor treatment device for septic tanks illustrated in FIG. 1 and FIG. 4 is a graph showing a test result of a comparative example which shows the amount of hydrogen sulfide generated in another equivalent septic tank not equipped with an odor treatment device.

As shown in FIG. 4, it can be seen that the average hydrogen sulfide concentration of about 26 ppm was generated at the exhaust port of the septic tank without the treatment device. However, as shown in FIG. 3, it can be seen that the average hydrogen sulfide of about 0.1 ppm was measured and the odor density was remarkably reduced after the odor treatment device 10 for septic tanks according to the present invention was installed.

Although the present invention has been described with reference to the exemplary embodiments illustrated in the drawings, those are only examples and may be changed and modified into other equivalent exemplary embodiments from the present invention by those skilled in the art. Therefore, the technical protective region of the present invention should be determined by the scope described in claims.

Using the odor treatment device for septic tanks according to the present invention, the following effects are achieved.

First, it is possible to basically preclude the generation of odor by performing the electrolytic oxidation processing on odor precursors and organic matters in the organic wastewater and by preventing secondary byproducts from being generated. This can be achieved by separately disposing the electrolytic oxidation module that uses an electric oxidation reaction mechanism, while keeping the function of the septic tank installed at a site as much as possible.

Second, as the electrodes are alternately arranged and either perforated or meshed plates are used in the electrode sets of the electrolytic oxidation module, the surface area can be maximized, and accordingly, the efficiency of electrolysis is improved.

Third, it is possible to not only effectively reduce odor by changing and automatically controlling the flow rate of the circulation pump and the voltage that is applied from the power supply unit based on the EC in the wastewater and the density of odor generated in the septic tank, but also considerably reduce electricity consumption.

While the present invention has been shown and described in connection with the exemplary embodiments, it will be apparent to those skilled in the art that modifications and variations can be made without departing from the spirit and scope of the invention as defined by the appended claims.

1. An odor treatment device for septic tanks, comprising:
an electrolytic oxidation module that has one or multiple electrode sets and processes odor precursors or organic matters that cause odor from organic wastewater and excretion flow inside by an electrolytic oxidation reaction;
a supply line through which the organic wastewater is supplied from a septic tank to the electrolytic oxidation module;
a circulation line through which the wastewater with the odor precursors and organic matters processed by the electrolytic oxidation module is circulated back to the septic tank;
a circulation pump that is disposed in the supply line and continuously circulates the organic wastewater;
a direct current power supply unit that supplies power to the electrode sets of the electrolytic oxidation module; and
a pump power supply unit that supplies power to the circulation pump.

2. The device of claim 1, further comprising a central control unit that controls the direct current power supply unit and the pump power supply unit.

3. The device of claim 2, further comprising an odor sensor that measures odor at an exhaust port of the septic tank,
wherein the central control unit controls power supplied to the electrode sets of the electrolytic oxidation module from the direct current power supply unit based on the degree of odor measured by the odor sensor.

4. The device of claim 2, further comprising an electric conductivity (EC) meter that measures EC in the septic tank,
wherein the central control unit controls the pump power supply unit to control a flow rate of the circulation pump based on the EC measured by the EC meter.

5. The device of claim 2, further comprising an effluent flow meter that measures an outflow rate at an outlet of the septic tank,
wherein the central control unit controls the pump power supply unit to control a flow rate of the circulation pump based on the outflow rate measured by the effluent flow meter.

6. The device of claim 1, wherein both electrodes, cathodes and anodes, are sequentially disposed in parallel to be spaced from one another in the electrode sets of the electrolytic oxidation module.

7. The device of claim 1, wherein the septic tank is divided into a precipitation tank, a first decomposition tank, and a second decomposition tank sequentially disposed along the flow of organic wastewater and excretion from the inlet,
the supply line is connected with the first decomposition tank or the second decomposition tank, and
the circulation line is connected with the second decomposition tank.

8. The device of claim 7, wherein the circulation pump is disposed in the first decomposition tank or the second decomposition tank where the supply line is connected.

9. The device of claim 7, wherein a filter unit for filtering is disposed in the second decomposition tank of the septic tank, and
an outlet end of the circulation line extends downward through the filter unit.

10. The device of claim 1, wherein the electrolytic oxidation module further includes a module case that has an inlet pipe and an outlet pipe for organic wastewater and excretion and includes the one or multiple pole plate sets therein
